(19) United States
(12) Patent Application Publication
(10) Pub. No.: US 2021/0048799 A1
(43) Pub. Date: Feb. 18, 2021

(54) METHODS AND SYSTEMS FOR REMOTE ISOLATION AND ENERGIZATION OF MECHANICAL EQUIPMENT

(71) Applicant: Hyperion North Holdings Inc., Lively (CA)

(72) Inventors: Eric Haapamaki, Lively, Ontario (CA); Andre Dumais, Lively (CA); Colin Roos, Lively (CA); Stephan Matusch, Lively (CA); Chris Morgan, Lively (CA); Chris Desmarais, Lively (CA)

(21) Appl. No.: 16/583,765

(22) Filed: Sep. 26, 2019

(30) Foreign Application Priority Data
Aug. 13, 2019 (CA) 3,051,907

(51) Int. Cl. G05B 19/418; G06F 1/3228

(52) U.S. Cl. CPC G05B 19/4185; G06F 1/3228; G05B 19/41865

(57) ABSTRACT

The present disclosure provides methods and systems for remotely isolating and energizing distributed mechanical equipment in an industrial environment. The methods and systems disclosed herein are able to remotely and safely isolate the primary sources of energy in industrial environments (e.g. electrical, hydraulic, and pneumatic) from mechanical equipment at a site from a single location. A method of installing a field isolation device for mechanical equipment in an industrial environment is also disclosed.

### CROSS-REFERENCE TO RELATED APPLICATIONS

This application claims priority to Canadian patent application number 3,051,907, filed on Aug. 13, 2019, the contents of which are incorporated herein by reference in its entirety for all purposes.

### STATEMENT RE: FEDERALLY SPONSORED RESEARCH/DEVELOPMENT

Not Applicable

### TECHNICAL FIELD

The present disclosure relates to isolating and energizing equipment, and in particular to methods and systems for remotely isolating and energizing multiple distributed mechanical equipment in an industrial environment.

### BACKGROUND

Industrial environments (e.g. mine sites, refineries, processing plants, lumber, steel mills) contain various types of large-scale equipment such as conveyors, separators, crushers, etc. When maintenance or other routine interactions such as cleaning the equipment, clearing material buildup, responding to sensor detections, etc., are to be performed for the equipment at the site/plant, the equipment must be shutdown and isolated from their energy sources to prevent accidental start-up of the equipment while personnel are working at the equipment. Currently, to isolate the equipment personnel must travel to each piece of equipment desired to be isolated, shut off power to the respective equipment, and place a personal lock at the equipment indicating that the equipment has been isolated. This is often referred to as “locking out” the equipment.

Requiring personnel to travel large distances (sometimes on the order of kilometers) to isolate the equipment is time-consuming and results in extended downtime beyond just the time in which work is actually being carried out on the equipment. Also, when the equipment is to be re-energized after the work is complete, the substantially same process in reverse takes place with personnel travelling to respective pieces of equipment to remove their personal locks and energize the equipment. It is not uncommon for the time required to isolate equipment and re-energize equipment to be on the order of hours. Moreover, some sites/plants require frequent shutdown of equipment (e.g. daily). In some cases, the reduction of this procedure by minutes translates into significant savings.

Accordingly, systems and methods that enable remote isolation and energization of equipment remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a remote isolation system configured to remotely isolate and energize mechanical equipment;

FIG. 2 shows a representation of example network configurations of the remote isolation system;

FIGS. 3A and 3B depict a hardware schematic of a master isolation unit and a field isolation device, respectively;

FIG. 4 shows an isometric view of an example master isolation unit;

FIG. 5 shows an isometric view of an example field isolation device;

FIG. 6 shows a communication flow diagram for remotely isolating a plurality of mechanical equipment;

FIG. 7 shows a method of remotely isolating a plurality of mechanical equipment;

FIG. 8 shows a method of remotely energizing a plurality of mechanical equipment; and

FIG. 9 shows a method of installing a field isolation device for mechanical equipment.

It will be noted that throughout the appended drawings, like features are identified by like reference numerals.

### DETAILED DESCRIPTION

In accordance with one aspect of the present disclosure, a system for remotely isolating a plurality of mechanical equipment in an industrial environment is disclosed, comprising: a plurality of field isolation devices each associated with respective mechanical equipment, each of the plurality of field isolation devices comprising: an energy control interface comprising: an energy input interface connectable to an energy source; an energy output interface connectable to the respective mechanical equipment; and an energy isolation control for controllably isolating the respective mechanical equipment from the energy source; a communication interface configured to send and receive data over a communication network; and a processor configured to cause the energy isolation control to isolate the respective mechanical equipment from the energy source in response to receiving an isolation command via the communication interface; and a master isolation unit, comprising: an operator input; a communication interface configured to send and receive data over the communication network, and a processing unit, configured to: receive an isolation request from an operator through the operator input requesting isolation of the plurality of mechanical equipment; and send an isolation command via the communication interface over the communication network to each of the plurality of field isolation devices.

In a further aspect of the system, the energy source may be any one of: an electrical source; a hydraulic source; and a pneumatic source.

In a further aspect of the system, the energy isolation control may be any one or more of: a switch, a relay, a contactor, a dump valve, a control valve, and a safety exhaust valve.

In a further aspect of the system, each of the plurality of field isolation devices may further comprise one or more sensors configured to measure a state of the respective mechanical equipment, and the processing unit of each of the plurality of field isolation devices may be further configured to send state data indicative of the measured state to the master isolation unit over the communication network.

In a further aspect of the system, the state of the respective mechanical equipment may comprise one or more of: under load, not under load, energizable, isolated, and isolated and safe.

In a further aspect of the system, sending the isolation command may comprise: receiving the state data from the plurality of field isolation devices; determining whether any of the plurality of mechanical equipment are under load based on the state data; and sending the isolation command to the plurality of field isolation devices when it is determined that none of the plurality of mechanical equipment are under load.

In a further aspect of the system, the master isolation unit may comprise one or more indicators that indicate isolation is not possible when it is determined that at least one of the plurality of mechanical equipment are under load.

In a further aspect of the system, the processing unit of the master isolation unit may be further configured to: determine the state of the plurality of mechanical equipment based on the state data; and when all of the plurality of mechanical equipment are in the isolated and safe state, indicate that isolation of the plurality of mechanical equipment is complete.

In a further aspect of the system, the master isolation unit may further comprise a physical locking apparatus, and when each of the plurality of mechanical equipment are in the isolated and safe state, the physical locking apparatus at the master isolation unit is able to be translated to a locking position permitting manual locking at the master isolation unit by an operator, and wherein the plurality of field isolation devices cannot reconnect the mechanical equipment to the energy source while the physical locking apparatus at the master isolation unit is in the locking position.

In a further aspect of the system, each of the plurality of field isolation devices may further comprise one or more indicators that indicate when the respective mechanical equipment is determined to be in the isolated and safe state.

In a further aspect of the system, the plurality of mechanical equipment may be a subset of all mechanical equipment in the industrial environment.

In accordance with another aspect of the present disclosure, a method of remotely isolating a plurality of mechanical equipment in an industrial environment is disclosed, comprising: receiving an isolation request through operator input at a master isolation unit requesting isolation of the plurality of mechanical equipment; determining at the master isolation unit whether any of the plurality of mechanical equipment are under load; when it is determined that none of the plurality of mechanical equipment are under load, isolating each of the plurality of mechanical equipment by sending an isolation command over a communication network from the master isolation unit to each of a plurality of field isolation devices each associated with respective of the plurality of mechanical equipment; determining a state of each of the plurality of mechanical equipment; and when all of the plurality of mechanical equipment are in an isolated and safe state, indicating at the master isolation unit that isolation is complete.

In a further aspect of the above method, each of the plurality of field isolation devices may be arranged between an energy source and the respective mechanical equipment, and in response to receiving the isolation command, each of the plurality of field isolation devices are configured to isolate energy supplied to the respective mechanical equipment from the energy source.

In a further aspect of the above method, the energy source may be any one of: an electrical source; a hydraulic source; and a pneumatic source.

In a further aspect of the above method, when it is determined that at least one of the plurality of mechanical equipment are under load, indicating at the master isolation unit that isolation is not possible.

In a further aspect of the above method, determining whether any of the mechanical equipment are under load and determining the state of the plurality of mechanical equipment may comprise receiving state data indicative of a measured state of the respective mechanical equipment from the plurality of field isolation devices over the communication network.

In a further aspect of the above method, the state of the respective mechanical equipment comprises one or more of: under load, not under load, energizable, isolated, and isolated and safe.

In a further aspect of the above method, the method further comprises: when each of the plurality of mechanical equipment are in the isolated and safe state, releasing a physical locking apparatus at the master isolation unit to allow for translation to a locking position permitting manual locking at the master isolation unit by an operator, and wherein the plurality of field isolation devices cannot reconnect the mechanical equipment to the energy source while the physical locking apparatus at the master isolation unit is in the locking position.

In a further aspect of the above method, the plurality of mechanical equipment may be a subset of all mechanical equipment in the industrial environment.

In accordance with another aspect of the present disclosure, a master isolation unit is disclosed, comprising: an operator input; a communication interface configured to send and receive data over the communication network, and a processing unit, configured to: receive an isolation request from an operator through the operator input requesting isolation of a plurality of mechanical equipment; and send an isolation command via the communication interface over the communication network to each of a plurality of field isolation devices each associated with respective of the plurality of mechanical equipment to isolate the respective mechanical equipment from an energy source.

In a further aspect of the above master isolation unit, the energy source may be any one of: an electrical source; a hydraulic source; and a pneumatic source.

In a further aspect of the above master isolation unit, the processing unit may be further configured to receive state data indicative of a measured state of the respective mechanical equipment from the plurality of field isolation devices.

In a further aspect of the above master isolation unit, the state of the respective mechanical equipment may comprise one or more of: under load, not under load, energizable, isolated, and isolated and safe.

In a further aspect of the above master isolation unit, sending the isolation command may comprise: receiving the state data from the plurality of field isolation devices; determining whether any of the plurality of mechanical equipment are under load based on the state data; and sending the isolation command to the plurality of field isolation devices when it is determined that none of the plurality of mechanical equipment are under load.

In a further aspect of the above master isolation unit, the master isolation unit may comprise one or more indicators that indicate isolation is not possible when it is determined that at least one of the plurality of mechanical equipment are under load.

In a further aspect of the above master isolation unit, the processing unit of the master isolation unit may be further configured to: determine the state of the plurality of mechanical equipment based on the state data; and when all of the plurality of mechanical equipment are in the isolated and safe state, indicating that isolation of the plurality of mechanical equipment is complete.

In a further aspect of the above master isolation unit, the master isolation unit may further comprise a physical locking apparatus, and when each of the plurality of mechanical equipment are in the isolated and safe state, the physical locking apparatus at the master isolation unit is able to be translated to a locking position permitting manual locking at the master isolation unit by an operator, and wherein the plurality of field isolation devices cannot reconnect the mechanical equipment to the energy source while the physical locking apparatus at the master isolation unit is in the locking position.

In a further aspect of the above master isolation unit, the plurality of mechanical equipment may be a subset of all mechanical equipment in the industrial environment.

In another aspect of the present disclosure, a field isolation device is disclosed, comprising: an energy control interface comprising: an energy input interface connectable to an energy source; an energy output interface connectable to mechanical equipment; and an energy isolation control for isolating the mechanical equipment from the energy source; a communication interface configured to send and receive data over a communication network; and a processor, configured to cause the energy isolation control to isolate the mechanical equipment from the energy source in response to receiving an isolation command via the communication interface.

In a further aspect of the above field isolation device, the energy source may be any one of: an electrical source; a hydraulic source; and a pneumatic source.

In a further aspect of the above field isolation device, the energy isolation control may be any one or more of: a switch, a relay, a contactor, a dump valve, a control valve, and a safety exhaust valve.

In a further aspect of the above field isolation device, the field isolation device may further comprise one or more sensors configured to measure a state of the mechanical equipment, wherein the processing unit is further configured to send state data indicative of the measured state to a master isolation unit over the communication network.

In a further aspect of the above field isolation device, the state of the mechanical equipment may comprise one or more of: under load, not under load, energizable, isolated, and isolated and safe.

In a further aspect of the above field isolation device, the field isolation device may further comprise one or more indicators that indicate when the mechanical equipment is determined to be in the isolated and safe state.

In another aspect of the present disclosure, a method of remotely energizing a plurality of mechanical equipment in an industrial environment is disclosed, comprising: receiving an energization request through operator input at a master isolation unit requesting energization of the plurality of mechanical equipment; sending an energization command over a communication network from the master isolation unit to each of a plurality of field isolation devices each associated with respective of the plurality of mechanical equipment instructing the field isolation devices to connect the associated mechanical equipment to a corresponding energy source; determining a state of the plurality of mechanical equipment; and when all of the plurality of mechanical equipment are in an energizable state, indicating at the master isolation unit that energization is complete.

In a further aspect of the above method, each of the plurality of field isolation devices may be arranged between the energy source and the respective mechanical equipment, and in response to receiving the energization command, each of the plurality of field isolation devices are configured to permit energy to be supplied to the respective mechanical equipment from the energy source.

In a further aspect of the above method, the energy source may be any one of: an electrical source; a hydraulic source; and a pneumatic source.

In a further aspect of the above method, determining the state of the plurality of mechanical equipment may comprise receiving state data indicative of a measured state of the respective mechanical equipment from the plurality of field isolation devices over the communication network.

In a further aspect of the above method, the state of the respective mechanical equipment may comprise one or more of: under load, not under load, energizable isolated, and isolated and safe.

In a further aspect of the above method, when it is determined that at least one of the plurality of mechanical equipment are not in the energizable state after a predetermined time from sending the energization command, indicating at the master isolation unit that a fault has occurred.

In a further aspect of the above method, the master isolation unit may further comprise a physical locking apparatus, and prior to energizing the plurality of mechanical equipment: determining whether the physical locking apparatus is in an unlocked position, and if the physical locking apparatus is in the unlocked position, sending the energization commands.

In a further aspect of the above method, the plurality of mechanical equipment may be a subset of all mechanical equipment in the industrial environment.

In another aspect of the present disclosure, a method of installing a field isolation device according to any of the above aspects for mechanical equipment in an industrial environment is disclosed, comprising: inserting the field isolation device between the energy source and the mechanical equipment; connecting the energy input interface of the energy control interface of the field isolation device to the energy source; and connecting the energy output interface of the energy control interface of the remote isolation unit to the mechanical equipment.

In a further aspect of the above method, the remote isolation unit may be inserted between the mechanical equipment and a field disconnect.

In a further aspect of the above method, energy supplied from the energy source may be electrical, and inserting the field isolation device between the energy source and the mechanical equipment comprises cutting an electrical cable between the energy source and the mechanical equipment, connecting a first end of the electrical cable connected to the energy source to the energy input interface, and connecting a second end of the electrical cable connected to the mechanical equipment to the energy output interface.

In a further aspect of the above method, the electrical cable may be a pre-existing electrical cable connecting the energy supply and the mechanical equipment.

In a further aspect of the above method, energy supplied from the energy source may be hydraulic or pneumatic, and inserting the field isolation device between the energy source and the mechanical equipment comprises connecting a first end of piping connected to the energy source to the energy input interface, and connecting a second end of piping connected to the mechanical equipment to the energy output interface.

In a further aspect of the above method, the piping may be pre-existing piping connecting the energy supply and the mechanical equipment.

The present disclosure provides methods and systems for remotely isolating and energizing distributed mechanical equipment in an industrial environment. The methods and systems disclosed herein are able to remotely and safely isolate the primary sources of energy in industrial environments (e.g. electrical, hydraulic, and pneumatic) from one, a subset, or all equipment at a site at a single location, and may be particularly advantageous when implemented for distributed, complex systems of mechanical equipment. A method of installing a field isolation device for mechanical equipment in an industrial environment is also disclosed.

The system disclosed is a pre-engineered, networked, lockout safety system that is able to isolate several distributed sources of potential energy in an industrial environment from a single remote location using control-reliable means. As the methods and systems disclosed herein are directed to be used in safety-related applications, the design has been developed to comply with standards which govern safety design such as CSA Z432 and ISO 13849. The system may be used to replace the existing ubiquitous procedure of disconnecting, locking, and tagging many physical disconnects. The system thus advantageously helps realize time savings to perform the task and eliminates human error.

The system is comprised primarily of two major devices: a master isolation unit, and a field isolation device. Each of the field isolation devices are associated with respective mechanical equipment and are configured to isolate the mechanical equipment from a source of energy (e.g. electrical, hydraulic, pneumatic). The field isolation devices are able to be connected between the energy source and the mechanical equipment, and comprise a control for isolating the mechanical equipment from the energy source. The mechanical equipment may include equipment that is operated under load from one or more energy sources. For example, large-scale equipment may have several components each being supplied with energy (e.g. the equipment may have several motors, pumps, actuators, drives, sparges, valves, etc.), and a field isolation device may be provided with each of these components as respective mechanical equipment.

The field isolation devices are installed between the energy source and the mechanical equipment. Where mechanical equipment receives multiple types of energy from different sources, a field isolation device may be provided for each energy source. For example, if a particular equipment receives both electric and hydraulic energy, a field isolation device may be provided to isolate the equipment from electric energy and a separate field isolation device may be provided to isolate the equipment from hydraulic energy. Alternatively, rather than providing multiple field isolation devices for each of the different energy sources used by a piece of mechanical equipment, it is possible to provide a single field isolation device that has multiple energy source disconnects for controllably isolating the mechanical equipment from the different energy sources.

The master isolation unit and field isolation devices work in conjunction with each other to remotely isolate the mechanical equipment in the industrial environment. An operator may remotely isolate and energize a plurality of mechanical equipment from the master isolation unit. When an industrial process system comprising one or more pieces of mechanical equipment needs to be isolated or energized, the isolation/energization request is received at the master isolation unit. The master isolation unit comprises one or more operator inputs that allows an operator to input commands such as “isolate”, “energize”, etc., for the mechanical equipment at the site or subsets of equipment. The master isolation unit is communicatively coupled with and able to remotely control the field isolation devices by sending commands thereto. The number of field isolation devices in an industrial environment may be as little as one, and as many as 200+ depending on the number of mechanical equipment and the different sources of energy supplied thereto.

The master isolation unit may receive state data from each of the plurality of field isolation devices indicative of a state of the respective mechanical equipment. For example, the state of the mechanical equipment may be “under load” if energy is currently being supplied to equipment, “not under load” if no energy is currently being supplied to the equipment, “energizable” if energy is able to be supplied to equipment, though the equipment may or may not be under load, “isolated” if the equipment is isolated from the energy source, and “isolated and safe” if the equipment is isolated from the energy source and the equipment is safe for personnel. Mechanical equipment may be considered safe for personnel if for example the mechanical equipment has stopped moving, has been de-energized, etc. The master isolation uses the state data to determine how to proceed with isolation/energization requests.

In accordance with the systems and methods disclosed herein, all energy sources can be safely isolated/energized within seconds of the request if the pieces of mechanical equipment are in an appropriate state to be isolated/energized. This may significantly reduce the amount of equipment downtime and personnel time required for isolating/energizing the equipment. Further, the systems and methods disclosed herein eliminate or at least reduce the possibility of human error when isolating the mechanical equipment and ensure a zero-energy state of the equipment is reached, thus reducing risks of injury, including for example arc flash risk, and improving the overall safety of the system.

The master isolation unit and field isolation devices may be provided with one or more indicators to indicate the status of the mechanical equipment. The master isolation unit may also be provided with a physical locking apparatus that allows a personal lock to be placed thereon when all of the desired equipment has been successfully isolated and is safe, and as long as the locking mechanism remains with a lock on it, the system will remain isolated.

The methods and system disclosed herein may be implemented in greenfield (new) or brownfield (existing) operations. The design of the field isolation device is such that one may bring a field isolation device into the isolating system by inserting the field isolation device between an energy source and the mechanical equipment. For example, if the field isolation device is configured to isolate mechanical equipment from electrical energy, the field isolation device may be installed by cutting the cable between the energy supply and its associated mechanical equipment. Once the cable is cut, the field isolation device may be inserted in series with the cable. This method of installation may be particularly advantageous in brownfield operations as the field isolation device may be installed without any extension to the existing cable.

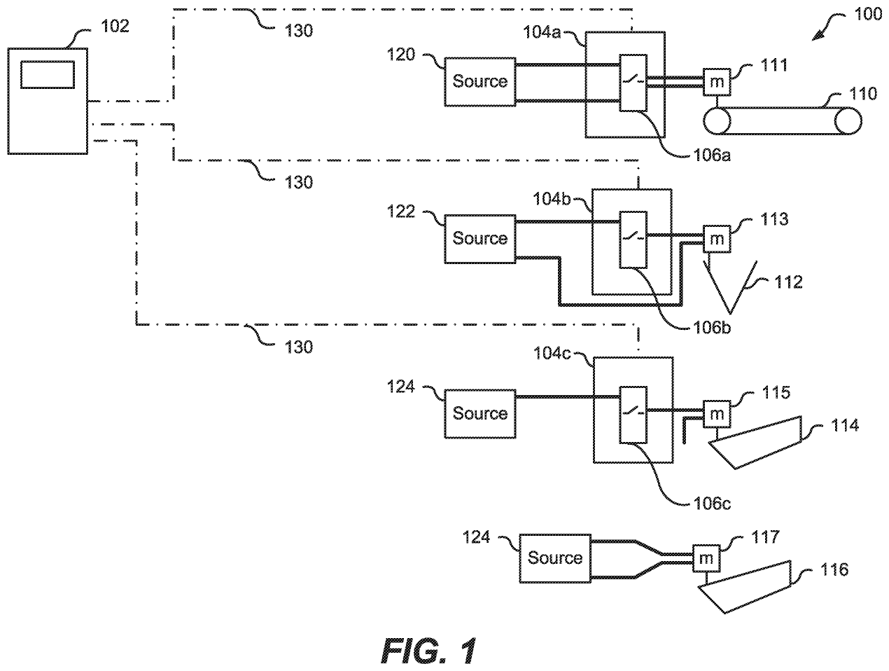

Embodiments are described below, by way of example only, with reference to FIGS. 1-9.

FIG. 1 shows a representation of a remote isolation system configured to remotely isolate and energize mechanical equipment in an industrial environment 100. The remote isolation system comprises a master isolation unit 102 and a plurality of field isolation devices 104a-c. Each of the plurality of field isolation devices 104a-c are associated with respective mechanical equipment and are configured to isolate the mechanical equipment from energy supplied to the mechanical equipment. For example, as depicted in FIG. 1 the field isolation device 104a is associated with a motor 111 of a conveyor 110, the field isolation device 104b is associated with a motor 113 of a crusher 112, and the field isolation device 104c is associated with a motor 115 of a screen 114. Each of the field isolation devices 104a-c are connected in series between an energy source 120, 122, 124 and the mechanical equipment such as motors 111, 113, and 115. The energy sources 120, 122, 124 may be any suitable source of energy for the equipment but will typically be one of an electrical source, a hydraulic source or a pneumatic source. The field isolation devices 104a-c may be installed after a field disconnect (not shown) of the equipment from the respective energy sources. Installing the field isolation devices 104a-c after the field disconnect of the respective equipment helps to facilitate detection of whether the mechanical equipment after isolation is safe for personnel, as will be further described herein.

Each field isolation device 104a-c comprise an energy isolation control, depicted as switches 106a, 106b, 106c, which controllably isolate the respective mechanical equipment from energy supplied thereto by the respective energy sources 120, 122, 124. The field isolation devices 104a-c may be connected by severing connections between the energy sources and mechanical equipment, and connecting the field isolation devices between the energy source and the mechanical equipment. As depicted in FIG. 1, the field isolation devices 104a-c are connected in series with at least a supply line (e.g. electrical cable, hydraulic/pneumatic piping) supplying energy from the energy source to the mechanical equipment. A return line from the mechanical equipment back to the energy source may be connected with the field isolation device as shown for field isolation device 104a, the return line may not be connected with the field isolation device as shown for field isolation device 104b, or a return line may not go back to the energy source and/or there may be no return line. FIG. 1 also depicts an additional piece of mechanical equipment comprising a motor 117 and a screening device 116 that are connected to an energy source 124. As depicted, the motor 117 has not been disconnected from the energy source 124 in contrast to the other motors 111, 113, 115, which have been disconnected from the respective energy sources in order to insert/install the field isolation devices 104a, 104b, 104c.

For the sake of example, the motor 111 of conveyor 110 may be an electric motor, the motor 113 of crusher 112 may be a hydraulic motor, and the motor 115 of the screen 114 may be a pneumatic motor. The field isolation device 104a is configured to isolate the motor 111 from electrical energy, the field isolation device 104b is configured to isolate the motor 113 from hydraulic energy, and the field isolation device 104c is configured to isolate the motor 115 from pneumatic energy. However, as would be appreciated by a person skilled in the art, mechanical equipment may be supplied with multiple sources of energy. For example, the crusher 112 may comprise equipment that is supplied with both hydraulic and electric energy. In this case, a separate field isolation device may be provided to isolate the mechanical equipment from the respective types of energy. The field isolation devices 104a-c are pre-engineered for the particular type of energy that they are designed to isolate.

Isolation of the mechanical equipment is performed by the field isolation devices 104a-c, and in particular the respective energy isolation controls 106a, 106b, 106c, in response to an isolation command from the master isolation unit 102. Operators/personnel can request at the master isolation unit 102 an isolation of a system of the mechanical equipment, a subsystem of mechanical equipment, or just individual mechanical equipment, depending on the configuration of the system. For safety reasons and to avoid human errors, specific subsets of equipment that are able to be isolated may be preconfigured at the master isolation unit 102. For example, an isolation request can be received to isolate a particular area of a plant, but not particular mechanical equipment within that area if it would be unsafe to isolate and shut down certain equipment without isolating others. In this manner, the master isolation unit 102 may be modularized, with the specific subsets of equipment hard-coded. An isolation command may be received requesting to isolate all of the mechanical equipment or specific subsets thereof in accordance with the configuration of the master isolation unit 102.

In response to receiving an isolation request from the operator through operator input, the master isolation unit 102 is configured to generate isolation commands instructing the field isolation devices 104a-c to isolate the mechanical equipment from the sources of energy. The systems and methods disclosed herein thus allow for remotely isolating a plurality of mechanical equipment from a single centralized location. The systems and methods disclosed herein also provide for remotely energizing the plurality of mechanical equipment from the master isolation unit 102, and in response to receiving an energization request from operator input the master isolation unit 102 generates and sends energization commands to the field isolation devices 104a-c.

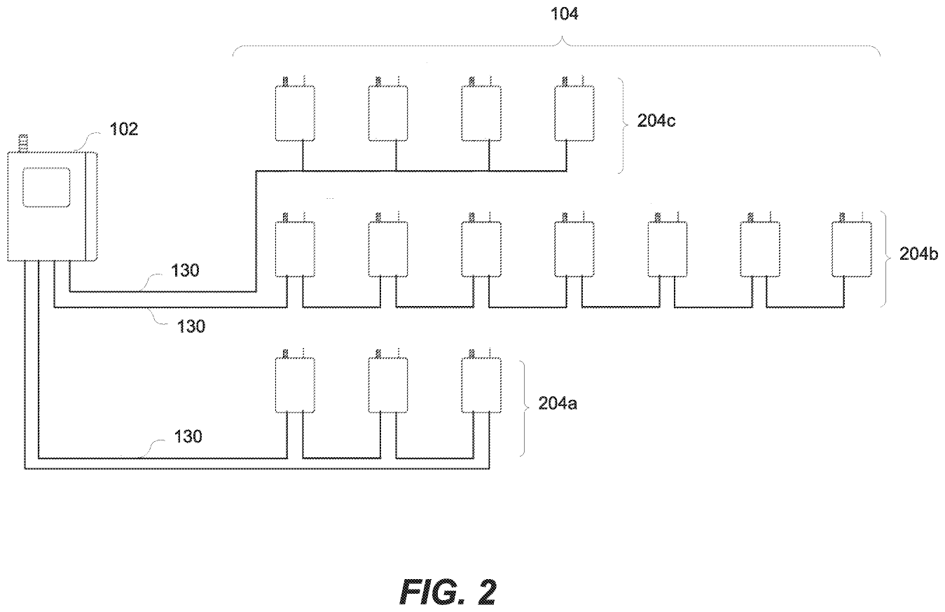

The master isolation unit 102 and the field isolation devices 104a-c are communicatively coupled over a communication network (depicted in FIG. 1 by network cables 130). Various communication networks such as an Ethernet network or Wi-Fi network are possible, provided that safety-related communication protocols such as Fail-Safe over Ethernet can be supported. The network cables 130 may be arranged in a variety of physical topologies. While FIG. 1 shows one possible communication network topology for a simple industrial environment comprising only three field isolation devices 104a-c, a person skilled in the art would appreciate that other types of physical network topologies are possible without departing from the scope of this disclosure. For example, FIG. 2 shows a representation of network configurations of the remote isolation system. FIG. 2 depicts an example communication network configuration of the remote isolation system with a modified-star network topology for different groups 204a, 204b, and 204c of field isolation devices 104. As depicted in FIG. 2, several types of connections between the master isolation unit 102 and the field isolation devices 104 are possible. For example, the network cables 130 connecting the master isolation unit 102 and the field isolation devices 104 of group 204a has a ring network topology, thus providing redundancy in the communication. The network cables 130 connecting the master isolation unit 102 and the field isolation devices 204b has a daisy-chain topology. As another example, the network cables 130 connecting the master isolation unit 102 and the field isolation devices 104 of the group 204c has a linear topology.

Further, while FIG. 1 depicts one example implementation of a remote isolation system comprising the master isolation unit 102 and the field isolation devices 104a-c, a person skilled in the art will readily appreciate that other implementations are possible without departing from the scope of this disclosure. For example, the remote isolation system can be scaled to include any number of field isolation devices being controlled by the master isolation unit 102, thus allowing for remote isolation of a plurality of mechanical equipment for various industrial environments. Moreover, although FIG. 1 depicts the conveyor 110, crusher 112, and screen 114 each having only a single motor, a person skilled in the art will also appreciate that large-scale equipment may have a plurality of mechanical equipment operating under load (e.g. multiple motors, pumps, etc.). A person skilled in the art will also appreciate that mechanical equipment may be provided with multiple sources of energy, and thus multiple field isolation devices may be associated with respective mechanical equipment.

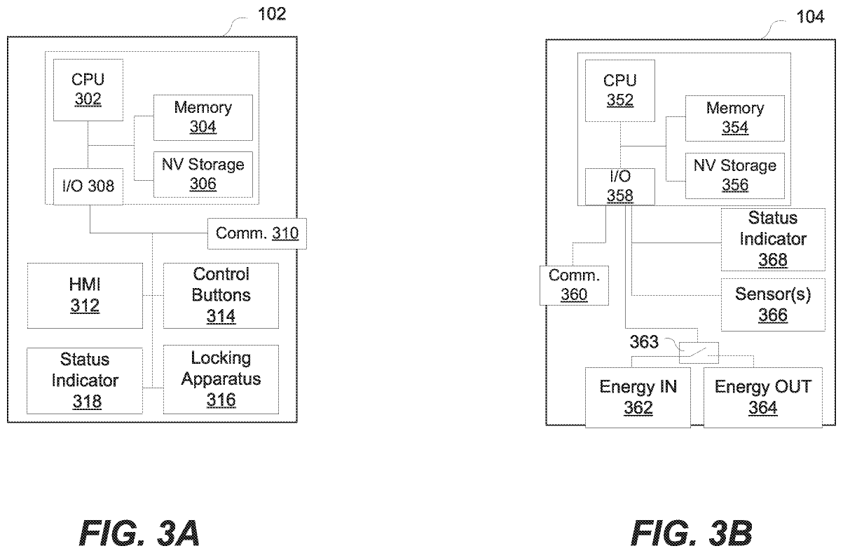

FIGS. 3A and 3B depict a hardware schematic of a master isolation unit 102 and a field isolation device 104, respectively.

As depicted in FIG. 3A, the master isolation unit 102 comprises computer elements including a processing unit for executing instructions which is depicted as a central processing unit (CPU) 302 although it may comprise a microprocessor, field programmable gate array (FPGA) or an application specific integrated circuit (ASIC), a non-transitory computer-readable memory 304, non-volatile storage 306, and an input-output (I/O) interface 308. The non-transitory computer-readable memory 304 stores computer-readable instructions which, when executed by the CPU 302, configures the master isolation unit 102 to perform certain functionality as will be further described herein. The master isolation unit 102 may be supplied with power from an external supply (not shown).

The I/O interface 308 couples the CPU 302 to various components of the master isolation unit 102. The master isolation unit 102 may comprise one or more indicators for presenting information to the operator/plant personnel, as well as one or more operator inputs for receiving input from an operator. As depicted in FIG. 3A, the master isolation unit 102 may comprise a Human-Machine Interface (HMI) 312, control push buttons 314, a physical locking apparatus 316, and status indicator lights 318. A person skilled in the art will appreciate that additional and/or alternative components may be provided. For example, instead of control buttons 314 operator inputs may be received through a touch-screen interface of the HMI. As another example, the master isolation unit 102 may be provided with speakers to provide auditory indications/notifications in addition to and/or alternative to visual.

The CPU 302 of the master isolation unit 102 sends/receives data through a communication interface 310. The communication interface 310 is configured to facilitate communication between the master isolation unit 102 and field isolation devices over the communication network. For example, where the communication network comprises Ethernet network cables running between the master isolation unit 102 and the field isolation devices, the communication interface 310 may comprise two M12 D-Code industrial Ethernet connectors that allow personnel to connect the Ethernet network cables to the master isolation unit 102.

An operator may input commands to the master isolation unit 102, for example via the control push buttons 314 and/or HMI 312. The CPU 302 may cause certain information to be displayed on the HMI 312. The HMI 312 located on the master isolation unit may be used to show important information about the status and health of the remote isolation system. The HMI 312 may indicate what the system is currently doing as well as present information or prompt an operator when necessary. For example, a system status screen may show the current state of each connected mechanical equipment in the system. The system status screen may present an equipment identifier, a communication status (e.g. OK or Faulted), and the equipment state (e.g. under load, not under load, energizable, isolated, isolated and safe, and no communication). A fault screen may show active faults in the system as well as the time they occurred.

During an isolation procedure, once all of the plurality of mechanical equipment are determined to be in an isolated and safe state, the physical locking apparatus 316 may be actuated to a locking position that allows an operator to slide the locking apparatus and permit the operator to manually place a lock at the locking apparatus. The locking apparatus 316 may for example be configured to slide in and out of the master isolation unit 102 and be controlled by, for example, a solenoid, electromagnet or other actuator (not shown).

Indicators such as the status indicator lights 318 may be used to indicate the state of the whole system comprising the plurality of mechanical equipment. The master isolation unit 102 may comprise one or more relays (not shown) that the CPU 302 can control for providing output signals for use in indicating a status of the system. The status indicator lights may comprise a plurality of LEDs and as a non-limiting example, a solid red light may indicate that the system is fully and safely isolated and a lock is installed at the locking apparatus; a flashing red light may indicate that the system is safely isolated and ready for a lock to be installed at the locking apparatus; a solid green light may indicate that the system is energized; a flashing green light may indicate that the system is in a transition state (e.g. either energization or isolation is in progress); and a yellow light may indicate that there is a fault present (i.e. the system is not operational to isolate/energize).

Additionally, as previously described the master isolation unit may in some implementations be modularized and configured for isolating subsets of the mechanical equipment in the industrial environment. Accordingly, modular components of the master isolation unit may be provided with respective control buttons, locking apparatus, and status indicator lights, for example. When an operator input is received at a particular module, the CPU 302 determines which subset of field isolation devices and/or mechanical equipment are to be controlled in response to the input (for example based on information of the subsets stored in memory 304), and the particular status indicator lights and locking apparatus of the module are controlled in response to the status/states of the subset of the mechanical equipment corresponding to that module.

As depicted in FIG. 3B, the field isolation device 104 comprises computer elements including a processing unit for executing instructions which is depicted as a central processing unit (CPU) 352 although it may comprise a microprocessor, field programmable gate array (FPGA) or an application specific integrated circuit (ASIC), a non-transitory computer-readable memory 354, non-volatile storage 356, and an input-output (I/O) interface 358. The non-transitory computer-readable memory 354 stores computer-readable instructions which, when executed by the CPU 352, configures the field isolation device 104 to perform certain functionality as will be further described herein. The field isolation device 104 may be supplied with power from an external supply (not shown).

The I/O interface 358 couples the CPU 352 to various components of the field isolation device 104. The field isolation device 104 may be provided with no operator inputs/controls so that only operator inputs can be received at the master isolation unit 102. As depicted in FIG. 3B, the field isolation device 104 may have one or more indicators such as status indicator lights 368 to visually indicate to an operator the status of the respective mechanical equipment associated with the field isolation device 104. Other types of indicators are also possible, such as speakers to provide auditory indications/notifications, and/or a non-interactive screen that displays information.

The CPU 352 of the field isolation device 104 sends/receives data through a communication interface 360. The communication interface 360 is configured to facilitate communication with the master isolation unit 102 over the communication network. For example, where the communication network comprises Ethernet network cables, the communication interface 360 may comprise two M12 D-Code industrial Ethernet connectors that allow personnel to connect the Ethernet network cables to the field isolation device 104.

The field isolation device 104 comprises an energy control interface having an energy input interface 362, an energy output interface 364, and an energy isolation control 363. The energy control interface is able to be connected between an energy source (with the energy from the energy source being received through the energy input interface 362) and the mechanical equipment that is being isolated (where the energy supplied to the mechanical equipment is output through the energy output interface 364). The energy isolation control 363 is configured to isolate the mechanical equipment from the energy source by restricting/interrupting the supply of energy between the energy input interface 362 and the energy output interface 364. The CPU 352 controls the energy isolation control 363 in response to commands received by the master isolation unit 102 via the communication interface 360.

The energy control interface is customized to the energy source that the field isolation device 104 is responsible for isolating. For example, if the field isolation device 104 is configured to isolate hydraulic power, the energy interface may be rated for the specific process requirements, which for the sake of example may require that the energy interface be rated for at least 3000 psi, accommodates a flow rate of at least 200 GPM, is able to withstand hydraulic oil, is corrosion resistant, and has an operating temperature range from −40° C. to 80° C. In another example, if the field isolation device 104 is configured to isolate pneumatic power, the energy interface may comprise a control circuit that is rated for at least 120 psi, accommodates a flow rate of at least 60 CFM, is corrosion resistant, and has an operating temperature range from −40° C. to 80° C. The energy isolation control 363 may comprise a contactor (e.g. redundant and fault monitoring safety contactor), switch, relay, etc., to isolate the mechanical equipment from electrical energy. For the sake of example, the energy isolation control 363 for isolating the mechanical equipment from electrical energy may be rated up to 1000 VAC, 3 PH/50/60 Hz, and up to 600 A. As would be appreciated by a person skilled in the art, larger voltages may be supported by using larger contactors for example, and the energy control interface may for example be configured for medium voltage lines carrying up to 13 kV. If the field isolation device 104 is isolating the mechanical equipment from hydraulic or pneumatic energy, the energy isolation control 363 may comprise a control valve, safety exhaust valve, dump valve, safety block and bleed valve, etc., to ensure isolation.

The field isolation device 104 further comprises one or more sensors 366 that are used for measuring a state of the mechanical equipment being isolated. If the field isolation device 104 is configured to isolate the mechanical equipment from electric energy, the sensor(s) 366 may for example comprise a voltmeter for measuring a voltage difference between the energy input interface 362 and energy output interface 364, an ammeter for measuring a current, voltage monitoring equipment for measuring a voltage difference between phases, etc. If the field isolation device 104 is configured to isolate the mechanical equipment from hydraulic or pneumatic energy, the sensor(s) 366 may comprise a flow meter to measure a flow rate and/or a pressure sensor to measure a hydraulic or pneumatic pressure. Spool/coil position sensor(s) may also be used for determining a position of the energy isolation control 363. The sensor(s) 366 are thus configured to measure data indicative of a state of the mechanical equipment, including states of “under load” if energy is currently being supplied to equipment, “not under load” if no energy is currently being supplied to the equipment, “energizable” if energy is able to be supplied to equipment, “isolated” if the equipment is isolated from the energy source, and “isolated and safe” if the equipment is isolated from the energy source and the equipment is safe for personnel. The mechanical equipment may be in more than one state. In particular, the mechanical equipment may be in an energizable state and under load, or the mechanical equipment may be in an energizable state and not under load. In the isolated state and the isolated and safe state, the equipment is not under load.

In an example implementation, if electrical energy is being supplied to the mechanical equipment, the sensor(s) 366 may comprise voltage monitoring equipment to measure a voltage difference between phases at the energy output interface 364 for use in determining whether the mechanical equipment is under load or not. In particular, if a voltage above a threshold voltage is detected between phases, the mechanical equipment may be considered as being under load. As an example, the voltage threshold may be set at 0.5 VAC. Low threshold voltages may result in false determinations that the equipment is under load, and as such a higher threshold voltage such as 3 VAC may be used to avoid false determinations. If the voltage between phases is less than or equal to the threshold a determination may be made that the mechanical equipment is not under load, and if the voltage between phases is more than the threshold a determination may be made that the mechanical equipment is under load. Further, by measuring the position of the energy isolation control 363 (e.g. whether a contactor/valve is open/closed), a determination can be made whether the equipment is in an isolated or energizable state. In the energizable state the energy isolation control 363 is in a position that allows energy to be supplied to the mechanical equipment, though whether energy is supplied or not (i.e. whether the equipment is under load or not) depends on whether the equipment is in operation. In the isolated state, the energy isolation control 363 is in a position that restricts/interrupts supply of energy or otherwise isolates the mechanical equipment. When isolated, the mechanical equipment is not under load.

However, even though the equipment is isolated and there is no energy being supplied or able to be supplied to the mechanical equipment, this does not necessarily guarantee a zero-energy state of the mechanical equipment or a state in which it is safe for personnel to access the equipment. For example, in an electric motor the motor may continue turning even after the electrical energy supplied to the motor has been stopped. The sensor(s) 366 may comprise a voltage monitoring component such that even if no electricity is being supplied from the energy source to the motor, if the motor is still turning a voltage is being generated that can be detected by the sensor 366 at the energy output interface 364, for example by measuring a difference in voltage between phases. Only when the voltage is zero or drops below a pre-determined threshold will a determination be made that the mechanical equipment is safely de-energized and the equipment is isolated and safe. The threshold may be the same or different than the value used for determining whether the mechanical equipment is under load or not. That is, once it is determined that the mechanical equipment is isolated, energy can be dissipated from the equipment to a safe level as appropriate. The energy isolation control may for example comprise electrical grounding or pressure release valves to dissipate some of the energy. In some instances energy may remain in the mechanical equipment for safety while shut down (for example, a hydraulic cylinder may retain hydraulic fluid at a certain pressure to maintain the equipment in a current position). The isolated and safe state of the mechanical equipment is thus a state in which energy cannot be supplied to the equipment, and there is no change of energy in the equipment (i.e. the equipment has reached a static steady-state).

Where the field isolation device 104 is configured to isolate mechanical equipment from hydraulic/pneumatic energy, similar measurements of the state of the mechanical equipment can be made. For example, a flow rate sensor may be used to indicate if hydraulic/pneumatic energy is being supplied to the mechanical equipment (e.g. whether the mechanical equipment is under load or not under load). As another example, a pressure sensor may be used to determine whether the mechanical equipment is isolated and safe. For example, if a pressure at the energy output interface 364 is greater than a predetermined threshold value, a determination may be made that the mechanical equipment is not fully isolated and/or is currently unsafe. The safe pressure threshold value may be for example between 0.5 psi and 10 psi.

In response to receiving an isolation command from the master isolation unit 102 (e.g. via the communication interface 360), the CPU 352 is configured to isolate the mechanical equipment by controlling the energy isolation control 363 to interrupt/restrict supply of energy to the mechanical equipment. Sensor data from the one or more sensors 366 may be provided to the CPU 352 via the I/O interface 358. As further described herein, state data of the mechanical equipment may be provided from the field isolation device 104 to the master isolation unit 102 (e.g. via the communication interfaces 310, 360). The state data is indicative of the state of the mechanical equipment based on the measurements by the one or more sensors 366. In some implementations, the CPU 352 may determine the state of the mechanical equipment and send the determined state as the state data to the master isolation unit 102. The CPU 302 thus determines the state of the mechanical equipment from the state determined by the CPU 352 and sent as the state data. In other implementations, the CPU 352 may not determine the state of the mechanical equipment and instead send the sensor measurements as state data to the master isolation unit 102 for the CPU 302 to determine the state of the mechanical equipment.

One or more indicators at the field isolation device 104 may be used to indicate the state of the mechanical equipment being isolated. For example, the indicators may comprise the status indicator lights 368, and a solid red light may indicate that the equipment is isolated and safe, a flashing red light may indicate that the equipment is isolated but not yet safe, a solid green light may indicate that the component is energized/under load; a flashing green light may indicate that the component is in a transition state (e.g. either energization or isolation is in progress, such as a no load state); and a yellow light may indicate that there is a fault present (i.e. the system is not operational to isolate/energize).

Although not depicted in FIGS. 3A and 3B, the master isolation unit 102 and the field isolation device 104 may comprise redundant components for additional safety and fault monitoring. For example, there may be two of CPUs 302 and 352 that respectively perform determinations/calculations, cross-check the results with the other processor, and if there is any discrepancy in the output then determine that there is a fault. Similarly, the energy isolation control 363 in the field isolation device 104 may for example comprise two contactors, each contactor checking their state and determining if there is a fault.

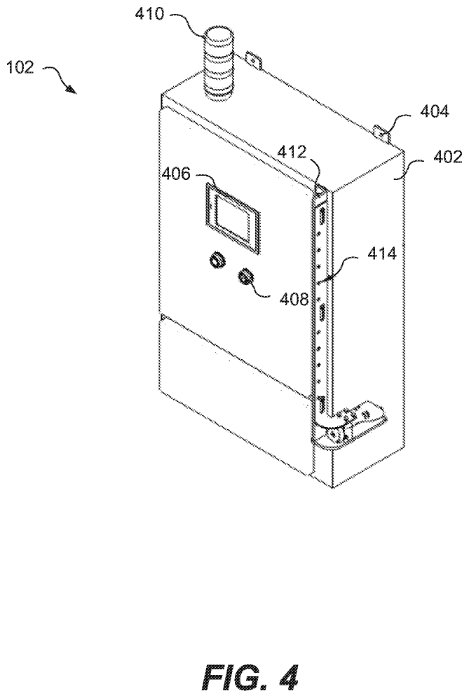

FIG. 4 shows an isometric view of an example master isolation unit 102. The master isolation unit 102 comprises an enclosure 402. Specifically, because of its intended use in heavy industrial process environments, such as mills, refineries and smelters, the enclosure 402 is a sealed, molded enclosures that may be IP67 rated. The master isolation unit 102 may comprise mounting bracket 404 for mounting on a wall or structure at a height suited for human interaction.

At the bottom of the master isolation unit 102 there are connectors for power and communications (not shown). For example, an interface for an external power supply, as well as the communication interface, may be provided. There is also an input/output interface (not shown) that is available to tie in to the plant control system.

Additionally, as described with reference to FIG. 3A, the master isolation unit 102 may comprise a human-machine interface 406, push buttons 408, a status indicator light 410, and a physical locking apparatus shown as a lockout slide 412. The lockout slide 412 may be provided on a sliding bracket 414.

Movement of the lockout slide 412 may be electrically and/or physically controlled. As one example implementation, when all of the mechanical equipment have been successfully isolated and are safe the processor of the master isolation unit may operate an electromagnet or solenoid valve, for example, to release the lockout slide 412 to a locking position that allows an operator to place a personal lock thereon. As a further example, operation of the electromagnet/solenoid valve may release the lockout slide 412 so that an operator may manually move the lockout slide 412 to the locking position for placing a personal lock thereon. In a particular implementation, the lockout slide 412 and the sliding bracket 414 may each have holes for affixing a lock there-through. The holes on the lockout slide 412 and the sliding bracket 414 may initially be misaligned when the lockout slide is held in place by the electromagnet/solenoid valve. However, releasing the lockout slide 412 may result in (or allow an operator to manually cause) movement of the lockout slide to a locking position so that the hole on the lockout slide 412 aligns with the hole on the sliding bracket 414. As long as the lockout slide 412 is in this position (i.e. by being locked in place by the lock), the mechanical equipment cannot be re-energized. A switch/relay may be used to indicate that the lockout slide 412 is in the locking position. Additionally/alternatively, a switch/relay may be used to indicate that the lockout slide 412 is in its original/unlocked position, and only once returned to this position (i.e. by removing the lock and displacing the lockout slide 412) can an energization request be performed (that is, energization cannot be performed in a lock is placed on the lockout slide). Triggering of the switch/relays in the original/locking positions may also result in indications being presented at the master isolation unit 102, for example by changing the lighting of the status indicator lights 410 to reflect the state of the system.

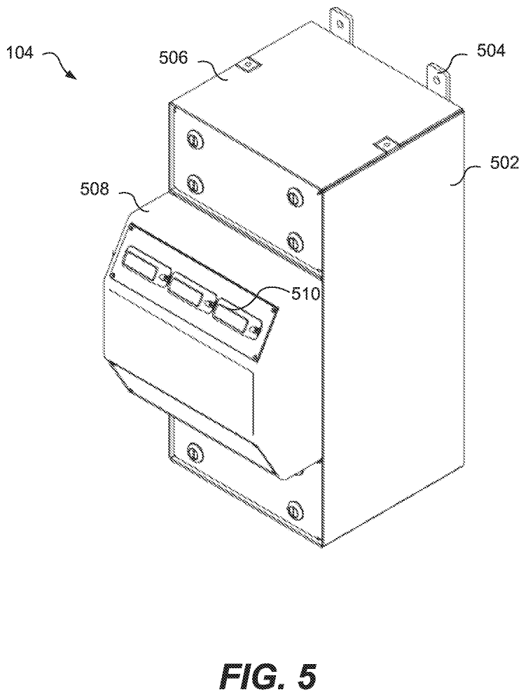

FIG. 5 shows an isometric view of an example field isolation device 104. The field isolation device 104 comprises an enclosure 502. The enclosure 502 is a sealed, molded enclosure that may be IP67 rated. The field isolation device 104 is intended to be mounted in the ‘field’ (meaning within the plant near the operating equipment). The field isolation device 104 may comprise mounting brackets 504.

The field isolation device 104 may comprise a power module 506 and a control module 508. Panels at the top and bottom of the power module 506 are accessible to the installing technician. The panel is punched with a hole and the wires are connected to lugs within the top and bottom panels. During installation, the top and bottom entry allows the user to cut a cable (in the case of the field isolation device 104 being configured to isolate electrical energy) and install it without having to add additional cable. One end of the cable may be connected at the top, and the other end of the cable connected at the bottom. On the front of the field isolation device there are indicators depicted as a series of status indicator lights 510. The field isolation device also comprises connectors for external power and communications.

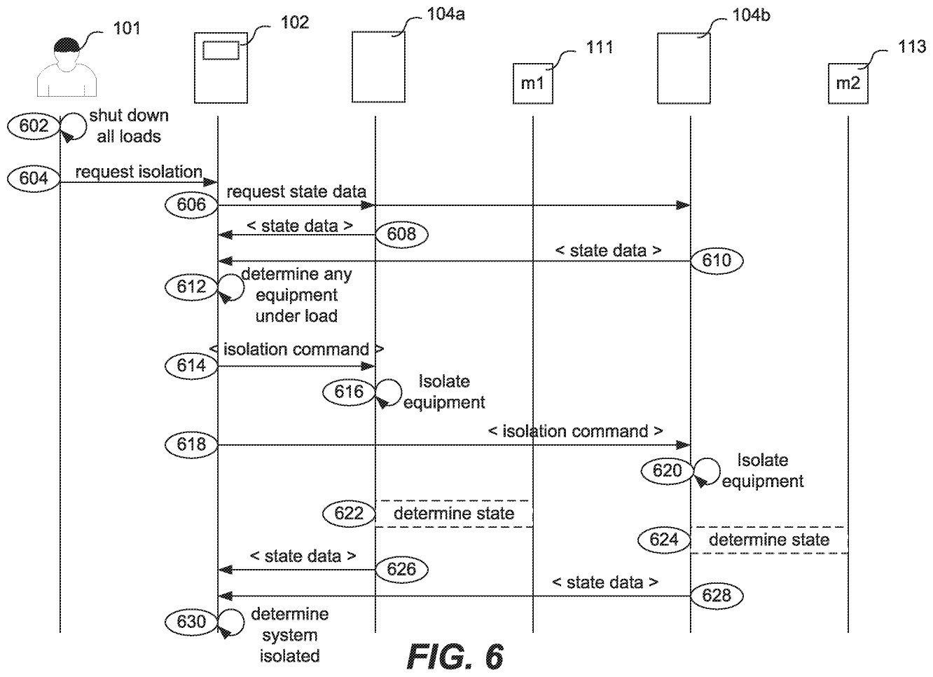

FIG. 6 shows a communication flow diagram for remotely isolating a plurality of mechanical equipment. An operator 101 shuts down all loads to be isolated (602), for example via a normal plant control system. The operator 101 makes an isolation request at the master isolation unit 102 that requests isolation of a plurality of mechanical equipment (604). For example, the operator 101 uses one or more operator inputs such as control push buttons at the master isolation unit 102 to select the equipment to be isolated and to make the isolation request. The HMI of the master isolation unit 102 may display information such as equipment status, communication faults, etc., pertaining to the request.

The master isolation unit 102 requests state data from each of the field isolation device 104a-b (606). If no state data is received in response to the request, the master isolation unit 102 may determine that there is a communication fault with the particular field isolation device and indicate such fault information on the HMI, for example. In the communication flow diagram of FIG. 6 the master isolation unit 102 receives state data from each of the field isolation devices 104a-b (608, 610). As described for example with reference to FIG. 3B, the field isolation devices 104a-b comprise one or more sensors that are used to measure various states of the mechanical equipment. Since the loads to the mechanical equipment have been shut down by the operator 101, the state data should indicate that the respective mechanical equipment are not under load unless there is a failure. The state data is indicative of the measured state of the respective mechanical equipment, and may be raw sensor data and other data that is interpreted by the processing unit at the master isolation unit 102, or the state data may comprise a determination by the processing units at the respective field isolation devices 104a-b as to whether the mechanical equipment are under load.

The master isolation unit 102 determines whether any of the mechanical equipment are under load based on the state data (612). The master isolation unit may determine whether respective mechanical equipment are under load when the state data comprises the sensor data, or state data may comprise this determination having been made at the field isolation devices and the master isolation unit determines whether any of the mechanical equipment are under load. When it is determined that none of the plurality of mechanical equipment are under load, the master isolation unit 102 generates an isolation command that instructs the field isolation devices 104a-b to isolate their associated mechanical equipment (in FIG. 6, motors 111 and 113). The master isolation unit 102 sends an isolation command to a first field isolation device 104a (614), and the field isolation device 104a isolates the motor 111 (616). The master isolation unit 102 also sends an isolation command to a second field isolation device 104b (618), and the field isolation device 104b isolates the motor 113 (620). Isolation of the equipment may be performed by opening a contactor or valve, for example. The configuration of the field isolation devices for performing the isolation has been described with reference to FIG. 3B, for example.

The field isolation devices 104a-b each determine the states of the motors 111 and 113, respectively (620, 622). For example, as described with reference to FIG. 3B the one or more sensors of the field isolation devices 104a-b may be used for detecting whether the motors 111 and 113 have achieved isolation and are completely safe (e.g. de-energized and/or reached a static steady state). In particular, even though no load may be supplied to the motors and the motors may be isolated, the motors may not yet be completely stopped. State data from the respective field isolation devices 104a-b is sent to the master isolation unit 102 (626, 628). The state data may be raw sensor data that is interpreted by the processing unit at the master isolation unit 102, or the state data may comprise a determination by the processing units at the respective field isolation devices 104a-b as to whether the mechanical equipment are isolated and safe. The master isolation unit 102 determines whether all of the mechanical equipment are in the isolated and safe state (630), and when it is determined that all of the mechanical equipment are fully and safely isolated, the master isolation unit 102 indicates that the isolation is complete.

The communication flow diagram shown in FIG. 6 is provided for the sake of example only and deviations in the flow may exist without departing from the scope of this disclosure. For example, the master isolation unit 102 may send isolation commands to the field isolation devices in sequence such that only after a first piece of equipment is in an isolated and safe state will an isolation command to isolate a second piece of equipment be sent. Further, a person skilled in the art will also appreciate that the communication flow diagram could be scaled to include more or less field isolation devices.

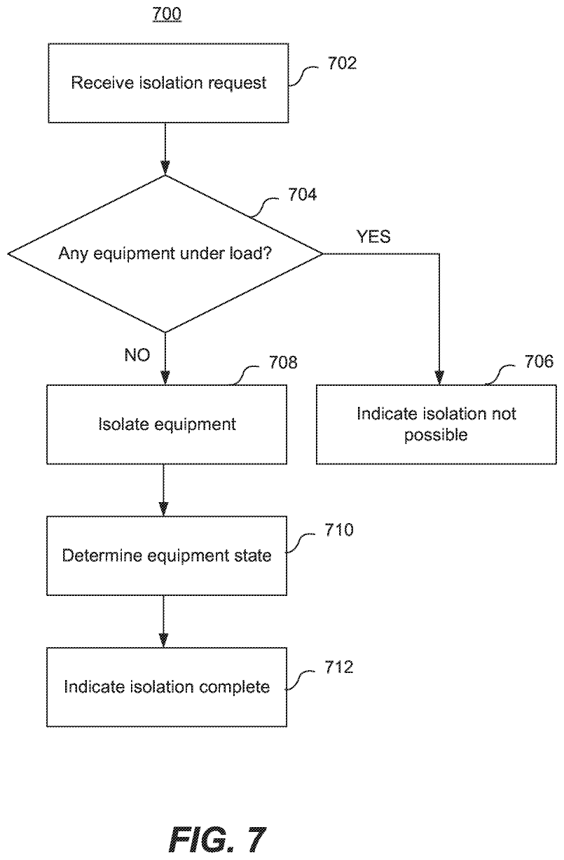

FIG. 7 shows a method 700 of remotely isolating a plurality of mechanical equipment. The method 700 may be implemented by the master isolation unit 102. The non-transitory computer-readable memory of the master isolation unit 102 may comprise computer readable instructions that when executed by the processor configures the master isolation unit 102 to perform the method 700.

An isolation request is received (702). The isolation request may request isolation of one or a plurality of mechanical equipment. The plurality of mechanical equipment may itself be a subset or the entirety of all mechanical equipment in the industrial environment. The isolation request may be received through operator input at the master isolation unit. The master isolation unit 102 may display an indication (for example flashing the status indicator lights green) to indicate that isolation is in progress.

A determination is made as to whether any of the plurality of mechanical equipment are under load (704). As described herein, the determination as to whether any of the plurality of mechanical equipment are under load may be made based on state data received from the plurality of field isolation devices associated with the mechanical equipment to be isolated. Prior to inputting an isolation request, an operator may shutdown all loads to equipment desired to be isolated via the normal plant control system. If any of the equipment are still under load (YES at 704), an indication is made that isolation is not possible (706). For example, the master isolation unit 102 may make this indication by way of displaying an output on the HMI and/or by displaying a certain colour of the status indicator lights (for example flashing yellow, indicating that a fault is present). A system status screen on the HMI may be used to identify equipment that are still energized so that an operator may try to shut down the loads to these equipment. After a predetermined period of time, a fault may be generated due to excessive time taken to run-down the equipment.

When it is determined that none of the plurality of mechanical equipment are under load (NO at 704), isolation of the equipment is initiated (708). The master isolation unit 102 sends an isolation command over the communication network to the plurality of field isolation devices. The field isolation devices perform isolation to isolate the equipment from a respective energy source. A state of the mechanical equipment is determined (710). As described herein, the determination of the isolated state of the mechanical equipment may be based on state data received from the plurality of field isolation devices. Equipment with no load and where the energy isolation control is controlled to isolate the equipment form the energy source will generally reach an isolated and safe state within a predetermined amount of time. If an isolated and safe state has not been reached by the end of the predetermined amount of time a fault may be present. In some instances, isolating the equipment and determining the state of the equipment may be performed sequentially for individual pieces of equipment to be isolated. That is, an isolation command may be sent to a first field isolation device, and when the equipment associated with the first field isolation device is in an isolated and safe state, an isolation command is sent to a second field isolation device. When all of the plurality of mechanical equipment are in the isolated and safe state, an indication is made that isolation of the system is complete (712). For example, the master isolation unit 102 may make this indication by way of displaying an output on the HMI and/or by displaying a certain colour of the status indicator lights (for example flashing red, indicating that the system is safely isolated and ready to be manually locked).

As described herein, the master isolation unit may be provided with a physical locking apparatus. When each of the plurality of mechanical equipment are in the isolated and safe state, the physical locking apparatus may be translated to a locking position that permits manual locking at the master isolation unit by an operator. For example, the locking apparatus may comprise a lockout slide that slides to a position that permits an operator to place a personal padlock thereon. Once the locking apparatus has been appropriately locked, a relay may be triggered that causes the status indicator lights to display a solid red light, for example, indicating that the system is safely isolated. The master isolation unit 102 may indicate a lockout timeout fault if the locking apparatus is not locked within a predetermined period of time.

Additionally, if a fault is determined to exist when isolating the equipment (for example, there is a fault in the communication between the master isolation unit and a field isolation device, a piece of equipment is unable to be isolated, etc.), the system may cause the equipment to fail to the isolated state for safety.

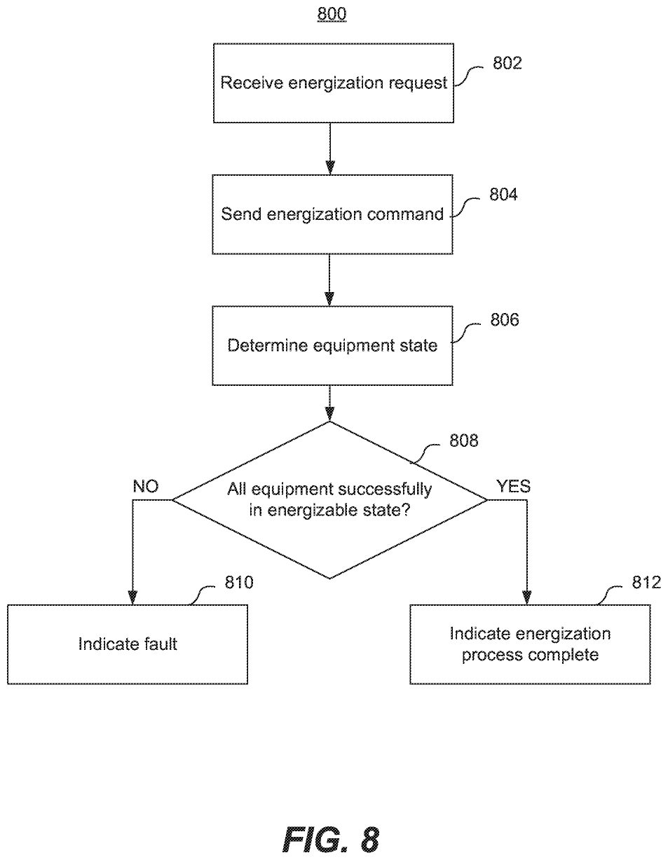

FIG. 8 shows a method 800 of remotely energizing a plurality of mechanical equipment. The method 800 may be implemented by the master isolation unit 102. The non-transitory computer-readable memory of the master isolation unit 102 may comprise computer readable instructions that when executed by the processor configures the master isolation unit 102 to perform the method 800.

An energization request is received (802). The energization request may request energization of one or a plurality of mechanical equipment. The plurality of mechanical equipment may itself be a subset or the entirety of all mechanical equipment in the industrial environment. The energization request may be received through operator input into the master isolation unit. The master isolation unit 102 may display a certain colour of the status indicator lights (for example flashing green) to indicate that energization is in progress.

The master isolation unit sends an energization command to each of the plurality of field isolation devices instructing the field isolation devices to permit energization of the equipment (804). With reference to FIG. 3B for example, upon receipt of the energization command the field isolation devices are configured to control the energy isolation control to a position that permits supply of energy to the mechanical equipment. A state of the mechanical equipment is determined (806). The determination of the state of the mechanical equipment may be based on state data received from the plurality of field isolation devices. The state data may be derived from sensor data measuring a position of the contactor/valve comprising the energy isolation control. In some instances, energizing the equipment and determining the energization state of the equipment may be performed sequentially for individual pieces of equipment to be energized. Sequentially transitioning the mechanical equipment to the energizable state may be particularly advantageous to reduce an inrush of energy into the system.

A determination is made if all of the mechanical equipment desired to be energized have successfully reached an energizable state (808). The energizable state is a state where energy may be supplied to the mechanical equipment, however no load is actually supplied to the equipment until the operation of the equipment is started via the normal plant control system, for example. If an equipment has failed to reach the energizable state (NO at 808), a fault is generated and indicated at the master isolation unit (810). In instances where the plurality of equipment is being sequentially energized and upon monitoring of the energized state it is determined that the current equipment being energized is failing to energize, energization of the remaining devices may or may not continue (the configuration of which may be process dependent). If all of the mechanical equipment desired to be energized have successfully reached the energizable state (YES at 808), an indication is made that energization process is complete (812). For example, the master isolation unit 102 may make this indication by way of displaying an output on the HMI and/or by displaying a certain colour of the status indicator lights (for example solid green, indicating that the system is energized).

As described herein, the master isolation unit may be provided with a physical locking apparatus. Prior to requesting energization, an operator may remove their personal lock so that the locking apparatus is moved back to an unlocked or original position. The master isolation unit may check that the locking apparatus is not locked prior to initiating energization of equipment.

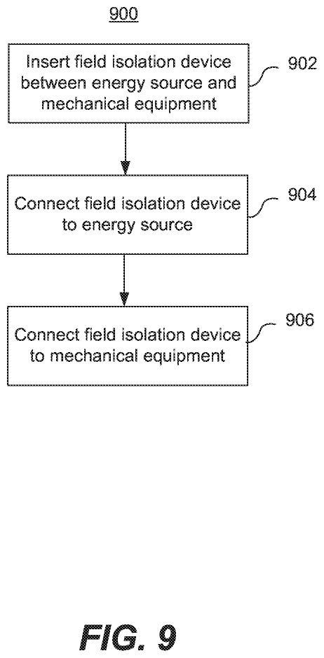

FIG. 9 shows a method 900 of installing a field isolation device for mechanical equipment. As has been described herein, the design of the field isolation device provides a simple installation method that can readily be implemented in existing operations.

The field isolation device is inserted between an energy source and the mechanical equipment (902). The field isolation device may be inserted between the mechanical equipment and a field disconnect to facilitate detection of the isolated and safe state of the equipment. The field isolation device is connected to the energy source by connecting the energy input interface of the energy control interface to the energy source (904). The field isolation device is connected to the mechanical equipment by connecting the energy output interface of the energy control interface to the mechanical equipment (906).

When the energy being isolated is electrical, inserting the field isolation device may comprise cutting an electrical cable between the energy source and the mechanical equipment, connecting a first end of the electrical cable that is connected to the energy source to the energy input interface of the energy control interface, and connecting a second end of the electrical cable connected to the mechanical equipment to the energy output interface. In some implementations, the electrical cable may be a pre-existing cable that connected the energy supply and the mechanical equipment, and any electrical energy in the cable is grounded before installation. With this method of installation, no adjustments to the length of the cable are required.

When the energy being isolated is hydraulic or pneumatic, inserting the field isolation device between the energy source and the mechanical equipment may comprise connecting a first end of piping connected to the energy source to the energy input interface of the energy control interface, and connecting a second end of piping connected to the mechanical equipment to the energy output interface of the energy control interface. In some implementations, the piping may be pre-existing piping that connected the energy source and the mechanical equipment, and any hydraulic or pneumatic energy in the piping is drained back to tank or released to atmosphere before installation. With this method of installation, no adjustments to the length of the piping are required.

It would be appreciated by one of ordinary skill in the art that the system and components shown in Figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

1. A system for remotely isolating a plurality of mechanical equipment in an industrial environment, comprising:
a plurality of field isolation devices each associated with respective mechanical equipment, each of the plurality of field isolation devices comprising:
an energy control interface comprising:
an energy input interface connectable to an energy source;
an energy output interface connectable to the respective mechanical equipment; and
an energy isolation control for controllably isolating the respective mechanical equipment from the energy source;
a communication interface configured to send and receive data over a communication network; and
a processor configured to cause the energy isolation control to isolate the respective mechanical equipment from the energy source in response to receiving an isolation command via the communication interface; and
a master isolation unit, comprising:
an operator input;
a communication interface configured to send and receive data over the communication network, and
a processing unit, configured to:
receive an isolation request from an operator through the operator input requesting isolation of the plurality of mechanical equipment; and
send an isolation command via the communication interface over the communication network to each of the plurality of field isolation devices.

2. The system of claim 1, wherein the energy source is any one of:
an electrical source;
a hydraulic source; and
a pneumatic source.

3. The system of claim 1, wherein the energy isolation control is any one or more of: a switch, a relay, a contactor, a dump valve, a control valve, and a safety exhaust valve.

4. The system of claim 1, wherein each of the plurality of field isolation devices further comprise one or more sensors configured to measure a state of the respective mechanical equipment, and the processing unit of each of the plurality of field isolation devices is further configured to send state data indicative of the measured state to the master isolation unit over the communication network.

5. The system of claim 4, wherein the state of the respective mechanical equipment comprises one or more of: under load, not under load, energizable, isolated, and isolated and safe.

6. The system of claim 5, wherein sending the isolation command comprises:
receiving the state data from the plurality of field isolation devices;
determining whether any of the plurality of mechanical equipment are under load based on the state data; and
sending the isolation command to the plurality of field isolation devices when it is determined that none of the plurality of mechanical equipment are under load.

7. The system of claim 6, wherein the master isolation unit comprises one or more indicators that indicate isolation is not possible when it is determined that at least one of the plurality of mechanical equipment are under load.

8. The system of claim 5, wherein the processing unit of the master isolation unit is further configured to:
determine the state of the plurality of mechanical equipment based on the state data; and
when all of the plurality of mechanical equipment are in the isolated and safe state, indicate that isolation of the plurality of mechanical equipment is complete.

9. The system of claim 8, wherein the master isolation unit further comprises a physical locking apparatus, and when each of the plurality of mechanical equipment are in the isolated and safe state, the physical locking apparatus at the master isolation unit is able to be translated to a locking position permitting manual locking at the master isolation unit by an operator, and wherein the plurality of field isolation devices cannot reconnect the mechanical equipment to the energy source while the physical locking apparatus at the master isolation unit is in the locking position.

10. The system of claim 5, wherein each of the plurality of field isolation devices further comprise one or more indicators that indicate when the respective mechanical equipment is determined to be in the isolated and safe state.

11. The system of claim 1, wherein the plurality of mechanical equipment are a subset of all mechanical equipment in the industrial environment.

12.-19. (canceled)

20. A master isolation unit, comprising:
an operator input;
a communication interface configured to send and receive data over the communication network, and
a processing unit, configured to:
receive an isolation request from an operator through the operator input requesting isolation of a plurality of mechanical equipment; and
send an isolation command via the communication interface over the communication network to each of a plurality of field isolation devices each associated with respective of the plurality of mechanical equipment to isolate the respective mechanical equipment from an energy source.

21. The master isolation unit of claim 20, wherein the energy source is any one of:
an electrical source;
a hydraulic source; and
a pneumatic source.

22. The master isolation unit of claim 20, wherein the processing unit is further configured to receive state data indicative of a measured state of the respective mechanical equipment from the plurality of field isolation devices.

23. The master isolation unit of claim 22, wherein the state of the respective mechanical equipment comprises one or more of: under load, not under load, energizable, isolated, and isolated and safe.

24. The master isolation unit of claim 23, wherein sending the isolation command comprises:
receiving the state data from the plurality of field isolation devices;
determining whether any of the plurality of mechanical equipment are under load based on the state data; and
sending the isolation command to the plurality of field isolation devices when it is determined that none of the plurality of mechanical equipment are under load.

25. The master isolation unit of claim 24, wherein the master isolation unit comprises one or more indicators that indicate isolation is not possible when it is determined that at least one of the plurality of mechanical equipment are under load.

26. The master isolation unit of claim 23, wherein the processing unit of the master isolation unit is further configured to:
determine the state of the plurality of mechanical equipment based on the state data; and
when all of the plurality of mechanical equipment are in the isolated and safe state, indicating that isolation of the plurality of mechanical equipment is complete.

27. The master isolation unit of claim 26, wherein the master isolation unit further comprises a physical locking apparatus, and when each of the plurality of mechanical equipment are in the isolated and safe state, the physical locking apparatus at the master isolation unit is able to be translated to a locking position permitting manual locking at the master isolation unit by an operator, and wherein the plurality of field isolation devices cannot reconnect the mechanical equipment to the energy source while the physical locking apparatus at the master isolation unit is in the locking position.

28. The master isolation unit of claim 20, wherein the plurality of mechanical equipment are a subset of all mechanical equipment in the industrial environment.

29. A field isolation device, comprising:
an energy control interface comprising:
an energy input interface connectable to an energy source;
an energy output interface connectable to mechanical equipment; and
an energy isolation control for isolating the mechanical equipment from the energy source;
a communication interface configured to send and receive data over a communication network; and
a processor, configured to cause the energy isolation control to isolate the mechanical equipment from the energy source in response to receiving an isolation command via the communication interface.

30. The field isolation device of claim 29, wherein the energy source is any one of:
an electrical source;
a hydraulic source; and
a pneumatic source.

31. The field isolation device of claim 29, wherein the energy isolation control is any one or more of: a switch, a relay, a contactor, a dump valve, a control valve, and a safety exhaust valve.

32. The field isolation device of claim 29, further comprising one or more sensors configured to measure a state of the mechanical equipment, wherein the processing unit is further configured to send state data indicative of the measured state to a master isolation unit over the communication network.

33. The field isolation device of claim 32, wherein the state of the mechanical equipment comprises one or more of: under load, not under load, energizable, isolated, and isolated and safe.

34. The field isolation device of claim 33, further comprising one or more indicators that indicate when the mechanical equipment is determined to be in the isolated and safe state.

35.-48. (canceled)
